(19) United States
(12) Patent Application Publication
(10) Pub. No.: US 2011/0179663 A1
(43) Pub. Date: Jul. 28, 2011

(54) Stature measuring device and stature measuring method

(75) Inventor: Dong Hun Kang, Busan (KR)

(73) Assignee: Komelon Corporation

(21) Appl. No.: 12/801,038

(22) Filed: May 18, 2010

(30) Foreign Application Priority Data
Jan. 27, 2010 (KR) 10-2010-0007418

(51) Int. Cl. G01B 1/00; G01B 3/10

(52) U.S. Cl. 33/759; 33/512

(57) ABSTRACT

Disclosed herein are a stature measuring method and a stature measuring device using the method. The method includes securing an anchoring unit, coupled to a main body via a tape, to a building wall, moving the main body to a bottom in a state in which the anchoring unit is secured to the building wall, inputting a reference point setting signal in a state in which the main body comes into contact with the bottom, and moving the main body from the bottom to a position above an examinee's head, and measuring a distance from a point where the reference point setting signal is input to a point where the main body is moved above the examinee's head, thus determining the examinee's stature.

### BACKGROUND OF THE INVENTION

1. Field of the Invention

The present invention relates to a digital type stature measuring device for measuring an examinee's stature (height) and a stature measuring method using the same.

2. Description of the Related Art

A general device for measuring stature includes a base platform on which an examinee stands so as to measure his or her stature. A column extends from the base platform in such a way as to be erected from the ground. A guide unit is provided in the longitudinal direction of the column. A head touch bar is guided by the guide unit and freely moved up and down.

In general stature measuring devices, gradations are marked on the column to measure the height of the head touch bar, or the base platform is provided with a display which displays the height of the head touch bar as the head touch bar moves up and down.

Since the stature measuring device is a relatively large instrument, it is used in hospitals or the like but is scarcely used in typical homes because of the large volume of the stature measuring device.

Meanwhile, as the stature measuring device for conveniently measuring stature, a simple stature measuring device has been proposed. It is similar in shape to a tape measure, and includes a main body around which a tape is wound and an anchoring unit which is provided on an end of the tape.

Such a simple stature measuring device is constructed so that the anchoring unit is installed at a predetermined height and gradations are marked on the tape. Stature is measured by checking a distance that the main body has moved downward from the anchoring unit installed at a predetermined height using a gradation marked on the tape.

That is, the method of using the simple stature measuring device is as follows. After the anchoring unit is precisely installed at a predetermined height, for example, 2M of a building wall, the main body is moved down to come into contact with an examinee's head. The distance that the main body has moved down from the anchoring unit is checked, thus measuring the examinee's stature.

Thus, in the simple stature measuring device, it is very important to install the anchoring unit at a precise height. However, it is not easy to secure the anchoring unit precisely at a certain height on the wall of a building, for example, at a 2 meter height. That is, it is difficult to precisely measure the 2 meter height, and besides, it is not easy to precisely install the anchoring unit at the measured height.

Further, in the simple stature measuring device, in order to measure the distance that the main body has moved downward from an examinee's head, his or her head must be spaced apart from the main body while he or she is holding the main body, and then the main body must be observed so as to measure the downward moving distance. However, if the main body moves during the measuring process, the measured value may be in error.

### SUMMARY OF THE INVENTION

Accordingly, the present invention has been made keeping in mind the above problems occurring in the prior art, and an object of the present invention is to provide a novel device and method for measuring stature. The device does not require a base platform or a column, so that its volume is very compact, thus enabling easy installation and convenient use in typical homes and making it easy to store. Further, even if the device is installed at any height of the wall of a building, the device can be used without any problems. In the state in which a main body is in contact with the head at the time of measuring stature, a measured value can be output and maintained, thus perfectly preventing errors from being made during the work of installation, the measuring operation, and the process of checking the measured value.

In order to accomplish the above object, the present invention provides a stature measuring device including a main body having a bobbin receiving part formed therein, a bottom touch surface provided on a bottom of the main body, and a tape passing slot through which the bobbin receiving part communicates with an outside, a bobbin rotatably held in the main body, a tape wound at a first end thereof around the bobbin and exposed at a second end thereof to an outside of the main body through the tape passing slot, an anchoring unit coupled to the second end of the tape exposed to the outside of the main body and secured to a building wall, a moving distance measuring unit provided in the main body to measure a distance the tape moves to the bobbin, a reference point setting switch provided on the main body and generating a reference point setting signal, a control unit performing control such that the moving distance measuring unit measures a distance the tape moves into the main body with reference to a position of the tape when the reference point setting signal is generated and determining a stature value, an output unit provided on the main body and outputting the stature value determined by the control unit, and a battery provided in the main body and supplying power to the moving distance measuring unit, the control unit, and the output unit.

A spring may be provided in the bobbin to elastically support the bobbin in a direction in which the tape is wound.

The moving distance measuring unit may indirectly measure the moving distance of the tape by measuring an amount of rotation of the bobbin, or may directly measure the moving distance of the tape.

A stature value determining switch may be provided on the main body to generate a stature value determining signal, and the control unit may determine the stature value when the stature value determining signal is generated.

Further, in order to accomplish the above object, the present invention provides a stature measuring method, including securing an anchoring unit, coupled to a main body via a tape, to a building wall, moving the main body to a bottom in a state in which the anchoring unit is secured to the building wall, inputting a reference point setting signal in a state in which the main body comes into contact with the bottom, and moving the main body from the bottom to a position above an examinee's head, and measuring a distance from a point where the reference point setting signal is input to a point where the main body is moved above the examinee's head, thus determining the examinee's stature.

As is apparent from the above description, a device and method for measuring stature according to the present invention is advantageous in that it does not require a base platform or a column, so that its volume is very compact, thus enabling easy installation and convenient use in typical homes and making it easy to store, and it can be used without any problems even if the device is installed at any height on the wall of a building, and the measured value can be output and maintained in the state in which a main body is in contact with the head at the time of measuring stature, thus perfectly preventing errors from being made during the work of installing it, during the measuring operation, and during the process of checking the measured value.

### BRIEF DESCRIPTION OF THE DRAWINGS

FIG. 1 is a perspective view illustrating a stature measuring device according to an embodiment of the present invention;

FIG. 2 is an exploded perspective view of FIG. 1;

FIG. 3 is a conceptual sectional view illustrating the state in which the stature measuring device of FIG. 1 is installed;

FIG. 4 is a control block diagram of the stature measuring device of FIG. 1; and

FIGS. 5A to 5C are views sequentially illustrating a method of measuring stature using the device of FIG. 1.

### DESCRIPTION OF THE PREFERRED EMBODIMENTS

Hereinafter, the embodiment of the present invention will be described in detail with reference to the accompanying drawings so that those skilled in the art may easily embody the present invention. However, the present invention may be embodied in several forms and is not limited to the specific embodiment thereof. In order to clearly describe the present invention, parts which are not described herein are omitted in the drawings, and the same reference numerals are used throughout the different drawings to designate the same or similar components.

Herein, when a part “includes” a component, it means that the part does not include components other than the mentioned component but may include other components provided that there is no special indication to the contrary.

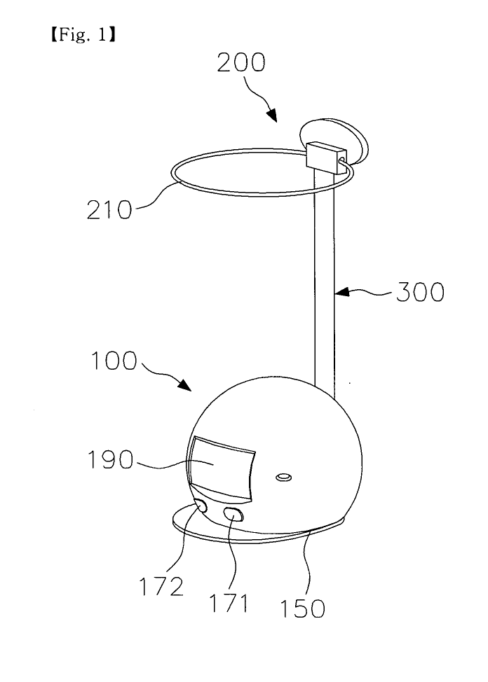

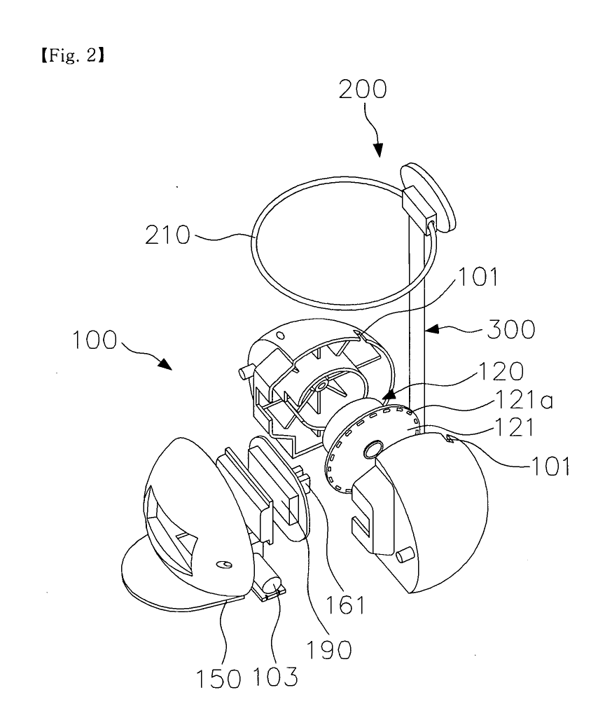

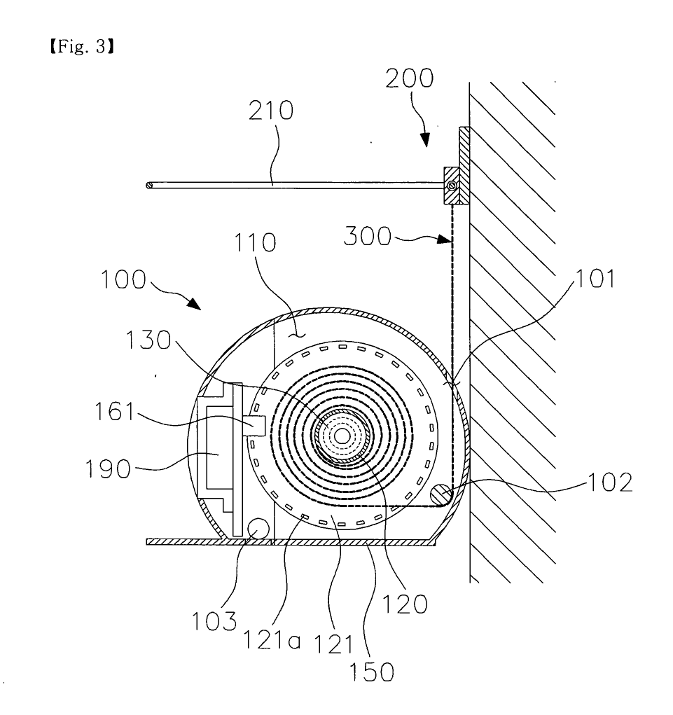

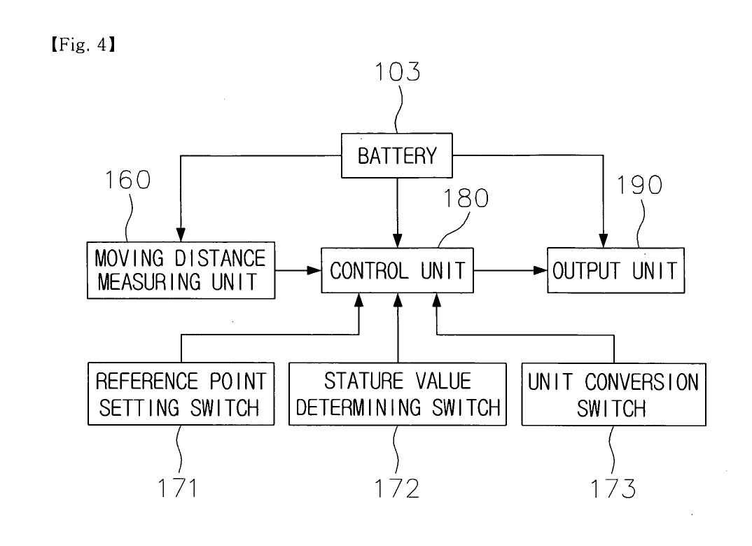

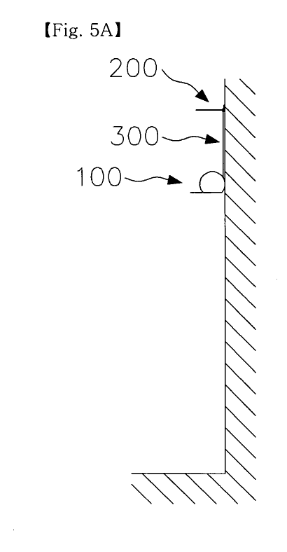

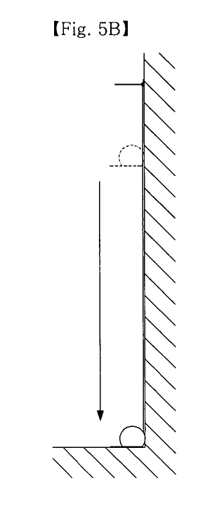

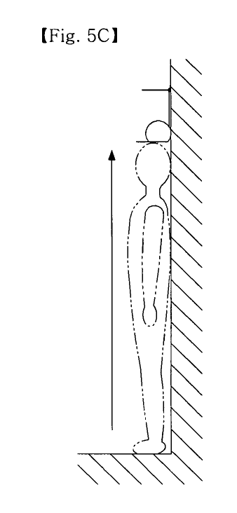

FIG. 1 is a perspective view illustrating a stature measuring device according to an embodiment of the present invention, FIG. 2 is an exploded perspective view of FIG. 1, FIG. 3 is a conceptual sectional view illustrating the state in which the stature measuring device of FIG. 1 is installed, FIG. 4 is a control block diagram of the stature measuring device of FIG. 1, and FIGS. 5A to 5C are views sequentially illustrating a method of measuring the stature using the device of FIG. 1.

The stature measuring device according to the present invention includes a main body 100, an anchoring unit 200, and a tape 300.

The anchoring unit 200 is the part which is secured to a building wall.

In order to secure the anchoring unit 200 to the building wall, a hole may be formed in the anchoring unit 200 such that a nail or the like passes through the hole, or an adhesive may be applied to the anchoring unit 200 so as to be attached to the building wall.

In order to limit the maximum upward moving range of the main body 100, a guide ring 210 is provided horizontally on the anchoring unit 200.

An end of the tape 300, exposed to the outside of the main body 100, is coupled to the anchoring unit 200.

The first end of the tape 300 is coupled to the anchoring unit 200, while the second end of the tape 300 is wound around a bobbin 120 of the main body 100.

Unlike the conventional simple stature measuring device, a construction for marking a length, such as gradations, is not printed on the tape 300 of this invention.

A bottom touch surface 150 is provided on the bottom of the main body 100.

The bottom touch surface 150 is used for two purposes. First, when the bottom touch surface 150 comes into contact with an examinee's head, the bottom touch surface 150 measures his or her stature. Second, when the bottom touch surface 150 comes into contact with the bottom, the bottom touch surface 150 establishes a reference point.

A bobbin receiving part 110 is defined in the main body 100 such that the bobbin 120 is rotatably held therein.

The bobbin 120 is rotatably received in the bobbin receiving part 110, with the second end of the tape 300 wound around the bobbin 120.

Further, a tape passing slot 101 is formed in the main body 100 to allow the bobbin receiving part 110 to communicate with the outside of the main body 100.

The second end of the tape 300 is wound around the bobbin 120, and the first end passes through the tape passing slot 101, is exposed to the outside of the main body 100, and then is coupled to the anchoring unit 200.

A spring 130 is provided in the bobbin 120. The spring 130 elastically supports the bobbin 120 in a direction of winding the tape 300.

Since the bobbin 120, the tape 300, and the spring 130 are almost equivalent to those of a general tape measure, and the combined construction of the bobbin 120, the tape 300, and the spring 130 is also disclosed in the conventional simple stature measuring device, the detailed description will be omitted herein. However, unlike the conventional tape measure or simple stature measuring device, the construction for marking a length by gradations, for example, is not printed on the tape 300 of this embodiment. Moreover, it is not necessary to print the length marking construction on the tape 300.

Reference numeral 102 denotes a guide roller 102 which is provided in the main body 100 so as to keep the tape 300 exposed to the outside of the main body 100 so that it is erected up vertically. The guide roller 102 guides the position of the tape 300.

Such a stature measuring device is provided with a moving distance measuring unit 160 to measure the distance that the tape 300 moves to the bobbin 120.

The moving distance measuring unit 160 functions to measure the moving distance in any one direction when the tape 300 is pulled out from the main body 100 or enters the main body 100 while being wound around the bobbin 120.

In order to measure the moving distance of the tape 300, two constructions may be applied to the moving distance measuring unit 160.

First, encoder slits are formed in the tape 300 in the longitudinal direction thereof, and a photo sensor is provided in the main body 100 to detect the encoder slits. Such a construction directly measures the moving distance of the tape 300.

Next, according to this embodiment, an encoder disc 121 having encoder slits 121a is provided on the bobbin 120. The encoder disc 121 is arranged coaxially with the bobbin 120 in such a way as to rotate along with the bobbin 120. A photo sensor 161 is provided in the main body 120 to detect the encoder slits 121a. Thereby, the moving distance of the tape 300 is measured using the rotation of the bobbin 120 which is rotated as the tape 300 is moved. That is, such a construction indirectly measures the moving distance of the tape 300 by measuring the amount of rotation of the bobbin 120. As such, in the case of using the amount of rotation of the bobbin 120, the moving distance of the tape 300 is determined in consideration of the amount of rotation of the bobbin 120 and the thickness of the tape 300 wound around the bobbin 120.

As another construction for indirect measurement, an encoder rotary part having encoder slits is provided in the main body 100 in such a way as to be in contact with the tape 300. As the tape 300 moves, the encoder rotary part which is in contact with the tape 300 is rotated, and the moving length of the tape 300 is measured using the rotation of the encoder rotary part. Such a construction is advantageous in that it is not necessary to consider the thickness of the tape 300, but is disadvantageous in that installation is complicated.

Meanwhile, the main body 100 is provided with a reference point setting switch 171, a stature value determining switch 172, and a unit conversion switch 173.

The reference point setting switch 171 generates a reference point setting signal according to a user's input, and is used to set a reference point.

The stature value determining switch 172 generates a stature value determining signal by a user's input, and is used to determine a stature value when the bottom touch surface 150 comes into contact with the head of an examinee.

The unit conversion switch 173 generates a unit conversion signal according to a user's input, and is used to convert the units of the stature value which is output to an output unit 190.

The control unit 180 performs control such that the moving distance measuring unit 160 measures the distance the tape 300 moves, thus determining a stature value. In detail, the moving distance measuring unit 160 measures a distance the tape 300 moves into the main body 100 with reference to the position of the tape 300 when the reference point setting signal is generated. Further, when the stature value determining signal is generated, the control unit 180 determines the final moving distance of the tape 300 as a stature value.

Further, the main body 100 is provided with the output unit 190 which outputs a stature value determined by the control unit 180. The output unit 190 may be an LCD screen which is output visually or a speaker which is output audibly, or may include both the LCD screen and the speaker. If necessary, the output unit 190 may be a projector which projects an enlarged stature value onto a wall which is in front of an examinee.

Further, a battery 103 is provided in the main body 100 to supply power to the moving distance measuring unit 160, the control unit 180, and the output unit 190. Of course, the battery 103 may be a dry battery or a storage battery.

A stature measuring method using the stature measuring device will be described with reference to FIGS. 5A to 5C.

First, as shown in FIG. 5A, the anchoring unit 200 of the stature measuring device is secured to the wall of a building or the like. Here, the anchoring unit 200 may be secured at any desired height permitting convenient use. It is not necessary for a user to check the height of the anchoring unit 200.

Next, as shown in FIG. 5B, in the state in which the anchoring unit 200 is secured, the main body 100 is pulled down to the bottom. When the bottom touch surface 150 of the main body 100 comes into contact with the bottom, the reference point setting switch 171 is pushed to input the reference point setting signal, so that the reference point setting switch 171 generates the reference point setting signal and transmits it to the control unit 180.

As such, an examinee's stature is measured with reference to the state of the tape 300 when the reference point setting signal is input to the control unit 180.

That is, when the reference point setting signal is input, the control unit 180 performs control such that the moving distance measuring unit 160 measures the distance the tape 300 moves into the main body 100.

Of course, when the stature measuring device is installed again, that is, when the height of the anchoring unit 200 of the stature measuring device changes, the reference point setting signal must be input to set the reference point.

When the setting of the reference point is completed as such, stature is measured.

That is, as shown in FIG. 5C, the main body 100 is moved up and an examinee is situated under the main body 100.

Thereafter, the main body 100 is placed above his or her head, that is, moved such that the bottom touch surface 150 comes into contact with the head.

In this state, when the stature value determining switch 172 is pushed, the stature value determining switch 172 transmits the stature value determining signal to the control unit 180. At this time, the control unit 180 determines the final moving distance of the tape 300 to be the stature value. The determined stature value is output by the output unit 190.

After the stature value determining switch 172 is operated, the unit conversion switch 173 is pushed, so that the unit of length which is displayed is changed.

According to this embodiment, the stature value determining switch 172 is provided and a user pushes the stature value determining switch 172. However, unlike this embodiment, when the measuring value of the moving distance measuring unit 160 stops changing, the moving distance of the tape 300 may be determined as the stature value using software, and the stature value may be output.

Further, after the reference point has been set, the main body 100 may be moved up to the maximum height. This height may be set as a secondary reference point, and the stature value may be measured with reference to the secondary reference point. However, even in this embodiment, a reference point setting operation using the bottom is necessarily required.

As this invention may be embodied in several forms without departing from the spirit of the essential characteristics thereof, the present embodiment is therefore illustrative and not restrictive. For example, the parts may be combined and arranged differently without departing from the spirit of the invention.

The scope of the present invention is defined by the appended claims rather than by the description preceding them, and all changes that fall within the meets and bounds of the claims, or the equivalents of such meets and bounds are intended to be embraced by the claims.

As described above, the present invention provides a device and method for measuring stature, which allows an examinee's stature to be conveniently measured.

What is claimed is:

1. A stature measuring device, comprising:
a main body comprising:
a bobbin receiving part formed therein;
a bottom touch surface provided on a bottom of the main body; and
a tape passing slot through which the bobbin receiving part communicates with an outside;
a bobbin rotatably held in the main body;
a tape wound at a first end thereof around the bobbin, and exposed at a second end thereof to an outside of the main body through the tape passing slot;
an anchoring unit coupled to the second end of the tape exposed to the outside of the main body, and secured to a building wall;
a moving distance measuring unit provided in the main body to measure a distance the tape moves to the bobbin;
a reference point setting switch provided on the main body and generating a reference point setting signal;
a control unit performing control such that the moving distance measuring unit measures a distance the tape moves into the main body with reference to a position of the tape when the reference point setting signal is generated, and determining a stature value;
an output unit provided on the main body, and outputting the stature value determined by the control unit; and
a battery provided in the main body, and supplying power to the moving distance measuring unit, the control unit, and the output unit.

2. The stature measuring device as set forth in claim 1, wherein a spring is provided in the bobbin to elastically support the bobbin in a direction in which the tape is wound.

3. The stature measuring device as set forth in claim 1, wherein the moving distance measuring unit measures an amount of rotation of the bobbin, thus indirectly measuring the moving distance of the tape.

4. The stature measuring device as set forth in claim 1, wherein the moving distance measuring unit directly measures the moving distance of the tape.

5. The stature measuring device as set forth in claim 1, wherein a stature value determining switch is provided on the main body to generate a stature value determining signal, and the control unit determines the stature value when the stature value determining signal is generated.

6. A stature measuring method, comprising:
securing an anchoring unit, coupled to a main body via a tape, to a building wall;
moving the main body to a bottom in a state in which the anchoring unit is secured to the building wall;
inputting a reference point setting signal in a state in which the main body comes into contact with the bottom; and
moving the main body from the bottom to a position above an examinee's head, and measuring a distance from a point where the reference point setting signal is input to a point where the main body is moved above the examinee's head, thus determining the examinee's stature.

7. The stature measuring method as set forth in claim 6, wherein the tape is wound at a first end thereof around a bobbin provided in the main body, and the bobbin is elastically supported by a spring in a direction in which the tape is wound and is rotatably held in the main body.
